(19) United States
(12) Patent Application Publication
(10) Pub. No.: US 2012/0072323 A1
(43) Pub. Date: Mar. 22, 2012

(54) MAINTAINING ONLINE FUNCTIONALITY DURING AN OUTAGE

(75) Inventors: Charles McAlister Clampett, St. Louis, MO (US); Wayne Keith Gordon, Denver, NC (US); Catherine E. Harris, Huntersville, NC (US); Matthew Allen Knight, Denver, NC (US); Joan C. Kuehl, Denver, NC (US); David Shroyer, Matthews, NC (US)

(73) Assignee: BANK OF AMERICA CORPORATION, Charlotte, NC (US)

(21) Appl. No.: 12/885,169

(22) Filed: Sep. 17, 2010

(51) Int. Cl. G06F 15/16; G06Q 40/00

(52) U.S. Cl. 705/35; 709/203

(57) ABSTRACT

A system maintains online functionality during an outage. The system includes a processing device configured for receiving a request for online interaction via a network from a client system and identifying a primary interaction system configured to respond to the request. The processing device is also configured for determining the primary interaction system is incapable of providing the online interaction associated with the request, identifying an alternative interaction system configured to respond to the request, and initiating an online interaction between the client system and the alternative interactive system. In some embodiments, the primary interaction system is incapable of providing website content, and the processing device initiates an exchange of alternative website content. In some embodiments, the primary interaction system is incapable of providing online banking information, and the alternative interaction system provides alternative online banking information such as non-current information regarding an account.

### FIELD

In general, embodiments of the invention relate to maintaining online functionality during an outage. More specifically, embodiments of the invention relate to systems for initiating an online interaction with an alternative interaction system in response to a request from a client system.

### BACKGROUND

In the current online environment for many organizations, system outages, such as hardware and/or software problems result in significant and often debilitating and comprehensive unavailability of online environment functionality, such as website functionality. In cases of financial institutions, merchants, or other organizations requiring secure interaction with customers, such as through authentication mechanisms and/or encrypted communications in order to carry out transactions or other business interactions, outages can greatly hinder customers' access to such services as online banking or online purchasing. In addition to creating hindrances to present interactions, such as with current customers, in some outage instances entire organizational websites are unavailable to customers and/or prospective customers thereby preventing users from retrieving information regarding the organization and, potentially, hurting future business for the organization. In outage situations, organizations typically do not communicate information regarding the outage to customers or others visiting websites, for example, and in some instances, organizations cannot communicate information regarding a repaired outage to users who visited during the outage because the organization does not know contact information for some users.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program products for maintaining online functionality during an outage.

According to embodiments of the present invention a method for maintaining online functionality during an outage includes receiving, at a processing device, a request for online interaction via a network from a client system, determining, by the processing device, the primary interaction system is incapable of providing the online interaction associated with the request, and initiating, by the processing device, an online interaction between the client system and an alternative interaction system. In some embodiments, the method also includes identifying, by the processing device, a primary interaction system configured to respond to the request. In some embodiments, the method also includes identifying, by the processing device, the alternative interaction system configured to respond to the request.

In some embodiments, the request for online interaction comprises a request for website content. In some such embodiments, determining the primary interaction system is incapable of providing the online interaction associated with the request includes determining the primary interaction system is incapable of providing the requested website content. In some such embodiments, initiating an online interaction between the client system and the alternative interaction system includes initiating an exchange of alternative website content between the client system and the alternative interaction system.

In some embodiments, the request for online interaction comprises a request for online banking In some such embodiments, initiating an online interaction between the client system and an alternative interaction system comprises initiating an online banking session between the client system and the alternative interaction system. In other such embodiments, the request for online banking includes a first request for online banking authentication and a second request for online banking information. In such embodiments, determining the primary interaction system is incapable of providing the online interaction associated with the request includes determining the primary interaction system is capable of providing authentication in response to the first request and is not capable of providing online banking information. In some such embodiments, the alternative interaction system is configured for providing alternative online banking information in response to the second request. In some such embodiments, the requested online banking information includes current information regarding one or more accounts and the alternative online banking information comprises non-current information regarding one or more accounts. In some such embodiments, the non-current information regarding one or more accounts comprises previous day information regarding the one or more accounts.

In some embodiments, the method also includes initiating, by the processing device, communication of a message to a client, the message comprising information regarding the outage. In some such embodiments, initiating communication of a message to a client is based at least in part on retrieved client contact information. In other such embodiments, the method also includes receiving, by the processing device, client contact information and initiating communication of a message to a client is based at least in part on the received client contact information. In yet other such embodiments, initiating communication of a message to a client comprises initiating communication of a message to the client system via the network. In yet other such embodiments, the method also includes receiving, by the processing device, client contact information and re-determining, after receiving the client contact information, by the processing device, that the primary interaction system is incapable of providing the online interaction associated with the request. In yet other such embodiments, initiating an online interaction between the client system and an alternative interaction system is performed at least in part concurrently with initiating communication of a message to a client.

According to embodiments of the present invention, a system maintains online functionality during an outage and includes a processing device. The processing device is configured for receiving a request for online interaction via a network from a client system, determining the primary interaction system is incapable of providing the online interaction associated with the request, and initiating an online interaction between the client system and an alternative interaction system. In some embodiments, the processing device is further configured for identifying a primary interaction system configured to respond to the request. In some embodiments, the processing device is further configured for identifying the alternative interaction system configured to respond to the request.

In some embodiments, the request for online interaction comprises a request for website content. In some such embodiments, determining the primary interaction system is incapable of providing the online interaction associated with the request includes determining the primary interaction system is incapable of providing the requested website content. In some such embodiments, initiating an online interaction between the client system and the alternative interaction system includes initiating an exchange of alternative website content between the client system and the alternative interaction system. In some embodiments, the request for online interaction comprises a request for online banking

In some such embodiments, initiating an online interaction between the client system and an alternative interaction system includes initiating an online banking session between the client system and the alternative interaction system. In other such embodiments, the request for online banking comprises a first request for online banking authentication and a second request for online banking information, wherein determining the primary interaction system is incapable of providing the online interaction associated with the request comprises determining the primary interaction system is capable of providing authentication in response to the first request and is not capable of providing online banking information. In some such embodiments, the alternative interaction system is configured for providing alternative online banking information in response to the second request. In some such embodiments, the requested online banking information comprises current information regarding one or more accounts and the alternative online banking information comprises non-current information regarding one or more accounts. In some such embodiments, the non-current information regarding one or more accounts comprises previous day information regarding the one or more accounts.

In some embodiments, the processing device is further configured for initiating communication of a message to a client, the message comprising information regarding the outage. In some such embodiments, initiating communication of a message to a client is based at least in part on retrieved client contact information. In other such embodiments, the processing device is further configured for receiving client contact information and wherein initiating communication of a message to a client is based at least in part on the received client contact information.

In some embodiments, initiating communication of a message to a client comprises initiating communication of a message to the client system via the network. In some embodiments, the processing device is further configured for receiving client contact information and re-determining, after receiving the client contact information, that the primary interaction system is incapable of providing the online interaction associated with the request.

In some embodiments, initiating an online interaction between the client system and an alternative interaction system is performed at least in part concurrently with initiating communication of a message to a client.

According to embodiments of the present invention, a computer program product configured for maintaining online functionality during an outage includes a non-transitory computer readable medium including computer-executable instructions stored therein. The computer-executable instructions include instructions for receiving a request for online interaction via a network from a client system, instructions for determining the primary interaction system is incapable of providing the online interaction associated with the request, and instructions for initiating an online interaction between the client system and an alternative interaction system.

In some embodiments, the instructions also include instructions for identifying a primary interaction system configured to respond to the request. In some embodiments, the instructions also include instructions for identifying the alternative interaction system configured to respond to the request. In some embodiments, the request for online interaction comprises a request for website content. In some such embodiments, the instructions for determining the primary interaction system is incapable of providing the online interaction associated with the request include instructions for determining the primary interaction system is incapable of providing the requested website content. In some such embodiments, the instructions for initiating an online interaction between the client system and the alternative interaction system include instructions for initiating an exchange of alternative website content between the client system and the alternative interaction system.

In some embodiments, the request for online interaction comprises a request for online banking In some such embodiments, the instructions for initiating an online interaction between the client system and an alternative interaction system include instructions for initiating an online banking session between the client system and the alternative interaction system. In some embodiments, the request for online banking includes a first request for online banking authentication and a second request for online banking information. In such embodiments, the instructions for determining the primary interaction system is incapable of providing the online interaction associated with the request include instructions for determining the primary interaction system is capable of providing authentication in response to the first request and is not capable of providing online banking information. In some such embodiments, the alternative interaction system is configured for providing alternative online banking information in response to the second request. In some such embodiments, the requested online banking information comprises current information regarding one or more accounts and the alternative online banking information comprises non-current information regarding one or more accounts. In some such embodiments, the non-current information regarding one or more accounts comprises previous day information regarding the one or more accounts.

In some embodiments, the instructions also include initiating communication of a message to a client, the message comprising information regarding the outage. In some such embodiments, the instructions for initiating communication of a message to a client include instructions for initiating communication of a message to a client based at least in part on retrieved client contact information. In some embodiments, the instructions also include instructions for receiving client contact information, and the instructions for initiating communication of a message to a client include instructions for initiating communication of a message to a client based at least in part on the received client contact information.

In some embodiments, the instructions for initiating communication of a message to a client include instructions for initiating communication of a message to the client system via the network. In some embodiments, the instructions also include instructions for receiving client contact information and instructions for re-determining, after receiving the client contact information that the primary interaction system is incapable of providing the online interaction associated with the request. In some embodiments, the instructions also include instructions for initiating an online interaction between the client system and an alternative interaction system and, at least in part concurrently, initiating communication of a message to a client.

According to embodiments of the present invention, a method for maintaining online functionality during an outage includes receiving, at a processing device, a request for online interaction comprising a request for website content via a network from a client system, identifying, by the processing device, a primary interaction system configured to respond to the request, determining, by the processing device, the primary interaction system is incapable of providing the online interaction, including the website content, associated with the request, identifying, by the processing device, the alternative interaction system configured to respond to the request, and initiating, by the processing device, an online interaction between the client system and an alternative interaction system comprising initiating, by the processing device, an exchange of alternative website content between the client system and the alternative interaction system.

According to embodiments of the present invention, a method for maintaining online functionality during an outage includes receiving, at a processing device, a request for online interaction via a network from a client system, the request comprising a first request for online banking authentication and a second request for online banking information, determining, by the processing device, the primary interaction system is incapable of providing online banking information in response to the request, and initiating, by the processing device, an online interaction between the client system and an alternative interaction system configured for providing alternative online banking information in response to the second request, the online banking information comprising current information regarding one or more accounts and the alternative online banking information comprising non-current information regarding one or more accounts. In some embodiments, the non-current information regarding one or more accounts comprises previous day information regarding the one or more accounts.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIGS. 1A-1C are block diagrams of environments in which systems operate according to embodiments of the present invention;

FIG. 2 is a flowchart illustrating a method for maintaining online functionality during an outage according to embodiments of the present invention;

FIG. 3 is a flowchart illustrating a method for maintaining online website content functionality during an outage according to embodiments of the invention;

FIG. 4 is a flowchart illustrating a method for maintaining online banking functionality during an outage according to embodiments of the invention; and

FIG. 5 is a flowchart illustrating a method for communicating a message to a client regarding an online functionality outage according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention provide a system that maintains online functionality during an outage. The system includes a processing device configured for receiving a request for online interaction via a network from a client system and identifying a primary interaction system configured to respond to the request. The processing device is also configured for determining the primary interaction system is incapable of providing the online interaction associated with the request, identifying an alternative interaction system configured to respond to the request, and initiating an online interaction between the client system and the alternative interactive system. In some embodiments, the primary interaction system is incapable of providing website content, and the processing device initiates an exchange of alternative website content. In some embodiments, the primary interaction system is incapable of providing online banking information, and the alternative interaction system provides alternative online banking information such as non-current information regarding an account.

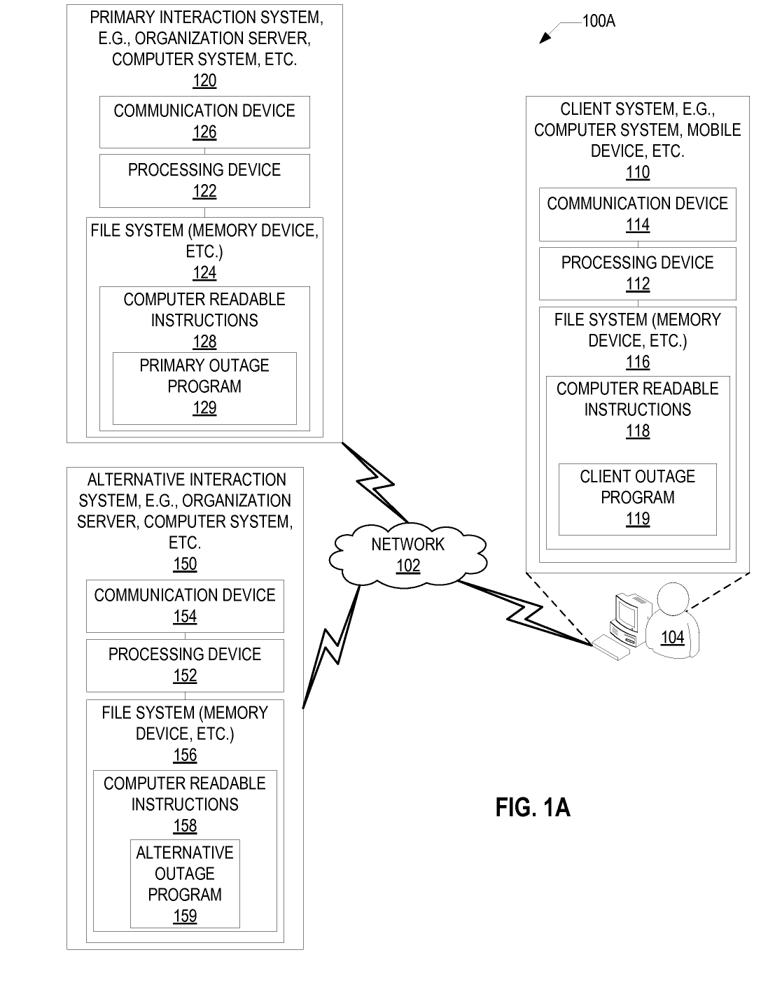

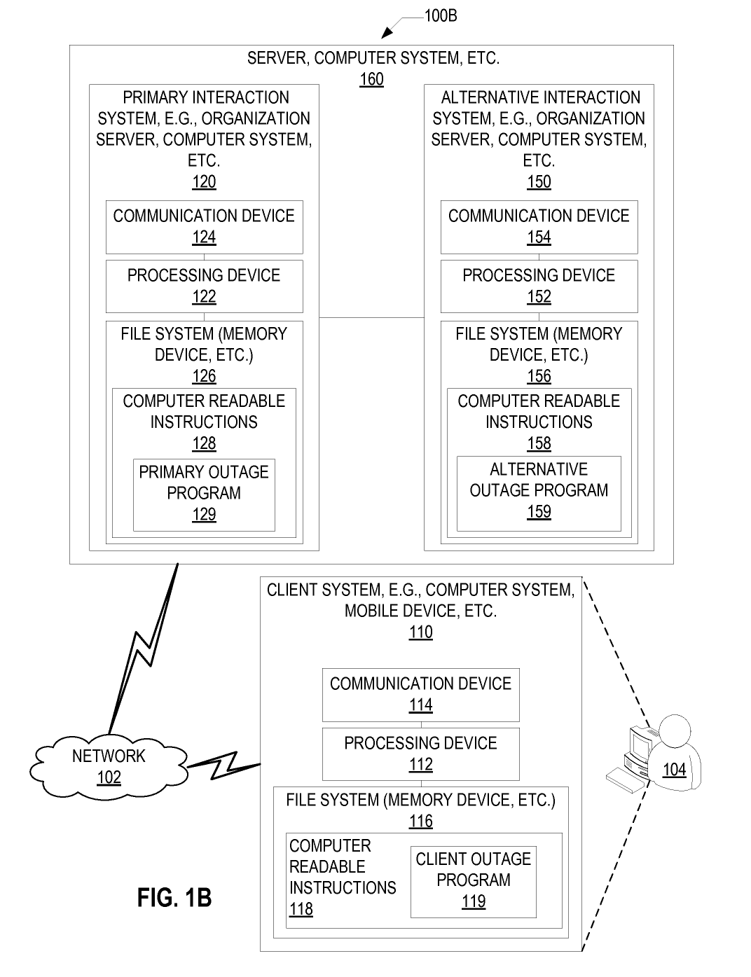

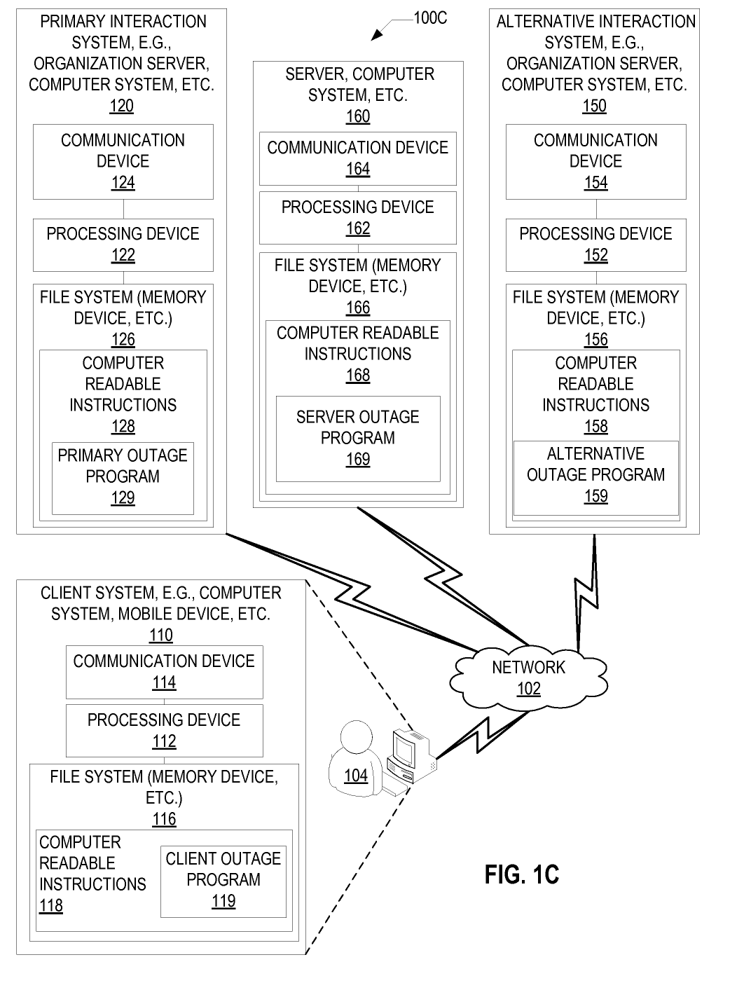

Referring concurrently now to FIGS. 1A-1C, block diagrams of environments 100A, 100B, and 100C, respectively, in which systems operate according to embodiments of the present invention are shown. FIG. 1A illustrates an environment 100A in which the primary interaction system 120, the client system 110 and the alternative interaction system 150 interact over a network 102. FIG. 1B illustrates an environment 100B in which the primary interaction system 120 and the alternative interaction system 150 are part of another server 160, computer system or the like. In this embodiment, the server 160 communicates with a client system 110 over the network 102 in accordance with embodiments of the present invention. FIG. 1C is a block diagram of an environment 100C in which the each of the server 160, the primary interaction system 120 and the alternative interaction system 150 are distinct systems. That is, they are not part of the same server, computer system or the like. Each of the systems 120 and 150 and the server 160 communicate over the network 102 with the client system 110. In some embodiments, one or more of the systems 110, 120, 150, and/or server 160 communicate directly with one another.

In the various embodiments, the client system 110 is a computer system, mobile device or other computing device used by a client 104 or other user to interact with an organization's online content and applications, such as by communicating with the primary interaction system 120. The client system 110 includes, in the embodiment shown, a processing device 112 communicatively coupled with a communication device 114 and a file system 116. The processing device, in some embodiments, is configured for controlling operation of the communication device 114 in order to communication across the network 102, such as, for example, with the primary interaction system 120 and/or the alternative interaction system 150. The file system 116 is or includes a memory device or other memory configured for storing computer readable instructions 118 such as an operating system, applications, such as a browser and others, other computer program code and the like. In some embodiments, the computer readable instructions include a client outage program 119 configured for instructing the processing device 112 to perform one or more of the methods and/or steps discussed herein. The client outage program 119, in some embodiments, is configured for instructing the processing device 112 to communicate with the primary interaction system 120 and/or the alternative interaction system 150 in order to request and ultimately provide online interaction to the client at the client system 110. The processing device 112, of course, is configured for accessing and/or retrieving some or all the computer readable instructions 118 and executing some or all of them.

In one embodiment, for example, the network 102 is an intranet or other local area network (LAN) and the client system 110, the primary interaction system 120, and the alternative interaction system 150 are all part configured for communicating with one another across the intranet. In such an embodiment, the client system, when directed by the client 104 to access a particular intranet webpage, uses a browser program to navigate to the intranet webpage. The browser and/or the client outage program 119 then requests online interaction, such as webpage content, from the primary interaction system 120. In the event the primary interaction system 120 is incapable of providing the online interaction, in some embodiments, the client outage program 119 directs the client system 110 to the alternative interaction system 150 to request alternative online interaction. In other embodiments, the primary interaction system 120 is running a primary outage program 129 that directs the primary interaction system to initiate an alternative online interaction between the client system 110 and the alternative interaction system 150.

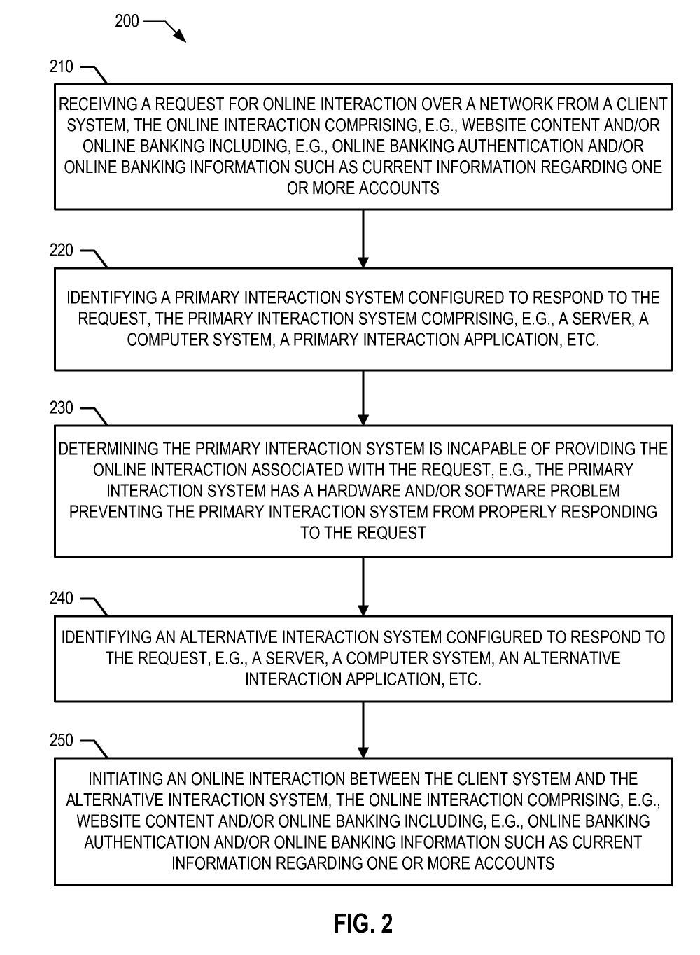

The primary interaction system 120, in some embodiments, is a server such as an organization server. In some embodiments, the primary interaction system 120 is maintained and/or owned by a financial institution such as a bank. In some such cases, the primary interaction system 120 is considered part of one or more backend systems of the bank. The primary interaction system 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the client system 110 and/or the alternative interaction system 150. The file system 124 is configured for storing computer readable instructions 128, such as, for example, the primary outage program 129, an operating system, other applications, other computer executable program code and the like. The primary outage program 129 includes program code and/or instructions for performing one or more of the methods and/or method steps discussed herein. For example, in one embodiment, the primary outage program 129 is configured for instructing the processing device 122 to receive a request for online interaction from the client system 110, determine the primary interaction system 120 is incapable of providing the online interaction, and initiating an online interaction between the client system 110 and the alternative interaction system 120 as discussed below with reference to FIG. 2. The processing device 122, of course, is configured to access and/or retrieve some or all the computer readable instructions 128 and execute some or all of them.

The alternative interaction system 150 is, in some embodiments, a server such as an organization server, a computer system, another computing device or the like. In some embodiments, the organization is a financial institution such as a bank and the alternative interaction system 150 is a financial institution server. In some instances, the alternative interaction system 150 is or is part of the bank's backend systems. The alternative interaction system 150, in some embodiments, includes a processing device 152 communicatively coupled with a communication device 154 and a file system 156. The processing device 152 is typically configured to control the communication device for communicating across the network 102 with one or more of the other systems, such as the primary interaction system 120 and/or the client system 110. The file system 156 is configured for storing computer readable instructions such as an alternative outage program 159, an operating system, other computer executable program code, applications and the like. The processing device 152 is configured for accessing and/or retrieving some or all the computer readable instructions 158 from the file system 156 and executing some or all of them. In some embodiments, for example, the alternative outage program 159 includes program code configured to instruct the processing device 152 to receive instructions for an online interaction with the client system 110. In some embodiments, the alternative outage program 159 includes instructions for exchanging alternative website content with the client system 110, and in other embodiments, the alternative outage program 159 includes instructions for exchanging online banking information with the client system 110.

Referring to FIGS. 1B and 1C, environments 100B and 100C, respectively, are shown wherein a server 160, computer system, other computing device or the like operates. The server 160, in the embodiment of FIG. 1B includes both the primary interaction system 120 and the alternative interaction system 150. In some such embodiments, the primary interaction system and the alternative interaction system share components, such as, for example, processing device 122 is the same device as processing device 152. Likewise, in some embodiments, file system 126 is the same system as file system 156. In various embodiments, the computer readable instructions of the server 160 include only one “outage program” including both the instructions of the primary outage program 129 and the instructions of the alternative outage program 159. In other embodiments, the computer readable instructions of the server 160 include multiple distinct outage programs, such as, for example, a distinct primary outage program 129 and a distinct alternative outage program 159. In some embodiments, the server 160 is configured for receiving a request from the client system 110 for online interaction, determining the primary interaction system 120 is incapable of providing the requested online interaction and initiating an online interaction between the alternative interaction system 150 and the client system 110. In some embodiments, such interactions with the client system 110 go through a communication device of the server 160 and in other embodiments, the server 160 initiates the interaction and the alternative interaction system 150 and the client system 110 interact directly. In some embodiments, the communication device 154 of the alternative interaction system is the communication device of the server 160. Similarly, in some embodiments, the communication device 124 of the primary interaction system 120 is the communication device of the server 160.

Referring now to FIG. 1C, the server 160 is separate and distinct from both the primary interaction system 120 and the alternative interaction system 150. In some embodiments, however, the server 160 includes either the primary interaction system 120 or the alternative interaction system 150. The server, in some embodiments, includes a processing device 162 communicatively coupled with a communication device 164 and a file system 166 such as a memory device, a memory or the like. The processing device 162 is configured for controlling the communication device 164 in order to communicate with one or more of the other systems, such as the primary interaction system 120, the alternative interaction system 150, and/or the client system 110. In some embodiments, the processing device 162 is configured for accessing and/or retrieving the computer readable instructions 168 from the file system 166 and then executing some or all the instructions. The computer readable instructions 168 include, in some embodiments, a server outage program 169 configured for instructing the processing device 162 to perform some or all the methods and/or method steps discussed herein. In one embodiment, for example, the server 160 receives the request from the client system, determines the primary system is incapable of providing the requested online interaction, and initiates an online interaction between the client system and the alternative interaction system as discussed in further detail below.

Referring now to FIG. 2, a flowchart illustrates a method 200 for maintaining online functionality during an outage according to embodiments of the present invention. First, as represented by block 210, a processing device, such as any of processing devices 122, 152 and/or 162 discussed above, receives a request for online interaction over a network, such as network 102 from a client system, such as client system 110. The online interaction includes, in various embodiments, for example, website content and/or online banking functionality such as online banking sessions including, for example, authentication and/or information. The online banking information, in various embodiments, includes current information regarding one or more accounts. The one or more accounts, for example, may be one or more bank accounts owned by the client 104 and maintained by a financial institution or bank that owns one or more of the systems 120, 150 and/or 160. In some embodiments, one or more of the communication devices, such as 126, 154, or 164 receives a communication from the communication device 154 of the client system 110. The one or more communication devices are typically controlled by a processing device, and the communication devices forward either the original request or a conditioned request to the processing device.

As represented by block 220, the processing device, such as 122, 152 and/or 162 identifies a primary interaction system, such as system 120, configured to respond to the request. In some embodiments, the processing device 122 of the primary interaction system 120 receives the request and identifies itself as the system configured to respond to the request. In other embodiments, a separate processing device receives the request and identifies the primary interaction system 120 as the system configured to respond to the request.

As represented by block 230, the processing device, such as 122, 152, and/or 162 determines the primary interaction system is incapable of providing the online interaction associated with the request. For example, in one embodiment, the primary interaction system 120 has a hardware and/or software problem preventing the primary interaction system 120 from properly responding to the request.

As represented by block 240, the processing device, such as 122, 152, and/or 162 identifies an alternative interaction system 150 configured to respond to the request. For example, in various embodiments, the processing device 122 of the primary interaction system 120 identifies the alternative interaction system 150 upon determining it is incapable of providing the requested online interaction.

As represented by block 250, the processing device, such as 122, 152, and/or 162 initiates an online interaction between the client system 110 and the alternative interaction system 150. The online interaction, as discussed above, may include, in various embodiments, exchange of website content, online banking functionality such as an online banking session including authentication and/or exchange of online banking information such as information regarding one or more accounts, such as one or more bank accounts owned by the client.

In some embodiments (see FIGS. 1B and 1C), for example, the processing device 162 of server 160 performs steps 210 through 250. In some embodiments, the server 160 is a separate system from the primary interaction system 120 and the alternative interaction system 150 and in other embodiments, one or both of the primary interaction system 120 and/or the alternative interaction system 150 are part of the server 160. In some embodiments, for example, the processing device 122 of the primary interaction system 120 performs steps 210 through 250 and the server 160 is uninvolved. In other embodiments, as discussed above, various components of the systems 120, 150, and/or 160 are indistinct and perform some or all of the steps 210 through 250. For example, in one embodiment, processing device 122 is processing device 152 and the processing device 122/152 performs each of steps 210 through 250.

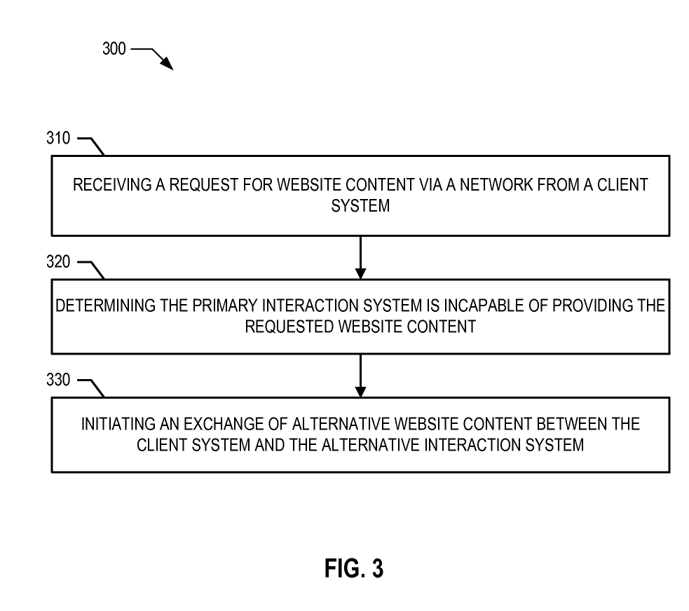

Referring now to FIG. 3, a flowchart illustrates a method 300 for maintaining online website content functionality during an outage according to embodiments of the invention. As represented by block 310, the first step is receiving a request for website content via a network from a client system. Step 310 is performed by one or more of the processing devices, such as 122, 152, and/or 162. In some embodiments, an optional step, similar to step 220 of FIG. 2 is performed. The optional step includes identifying a primary interaction system configured to respond to the request, and the optional step is performed by one or more processing devices, such as 122, 152, and/or 162.

As represented by block 320, the next step is determining the primary interaction system is incapable of providing the requested website content. This step is performed by one or more of the processing devices, such as 122, 152, and/or 162. In some embodiments, an optional step, similar to step 240 of FIG. 2 is performed. The optional step includes identifying an alternative interaction system configured to respond to the request, and the optional step is performed by one or more processing devices, such as 122, 152, and/or 162.

As represented by block 330, the next step is initiating an exchange of alternative website content between the client system 110 and the alternative interaction system 150. Step 330 is performed by one or more of the processing devices, such as 122, 152, and/or 162.

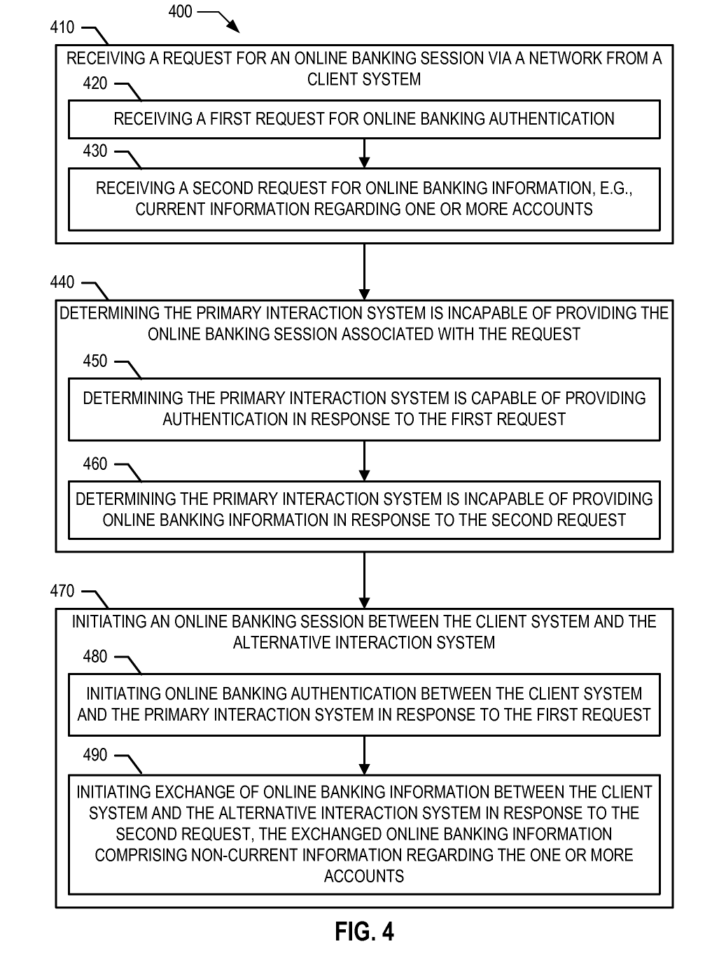

Referring now to FIG. 4, a flowchart illustrates a method 400 for maintaining online banking functionality during an outage according to embodiments of the invention. The first step, as represented by block 410 is receiving a request for an online banking session via a network from a client system. Step 410 is typically performed by a processing device, such as processing device 122, 152, and/or 162. Step 410, in some embodiments, includes receiving a first request for online banking authentication as represented by block 420. Step 410, in some embodiments, also includes receiving a second request for online banking information. For example, in some embodiments, the received request includes both the first request for authentication plus the second request for information. In some other embodiments, the request is split into two distinct requests, that is, the first request for authentication and the second request for information. In various embodiments, the second request for information includes a request for current information regarding one or more accounts owned by the client and typically maintained by a financial institution that owns, and in some embodiments, maintains one or more of the systems and servers discussed herein.

Next, as represented by block 440, the processing device, such as processing device 122, 152, and/or 162, determines the primary interaction system is incapable of providing the online banking session associated with the request. In some embodiments, step 440 includes determining that the primary interaction system is capable of providing authentication in response to the first request as represented by block 450. In some embodiments, sub-step 450 is a separate step performed by one or more of the processing devices. In some embodiments, step 440 also includes determining the primary interaction system is incapable of providing online banking information in response to the second request.

Thus, in some instances, the primary interaction system is capable of authenticating the client but is incapable of providing the online banking information requested. In other instances, and in other embodiments, the primary interaction system is incapable of authenticating the client and a determination is made by one or more processing devices that the primary interaction system is incapable of providing authentication in response to the first request. In various other instances and embodiments, one or more processing devices determines the primary interaction system is incapable of both providing authentication in response to the first request as well as providing online banking information in response to the second request.

As represented by block 470, the next step is initiating an online banking session between the client system and the alternative interaction system. In the embodiment shown, step 470 includes initiating online banking authentication between the client system and the primary interaction system in response to the first request. In other embodiments, such as an embodiment where the processing device determines the primary interaction system is incapable of providing online banking authentication, the processing device initiates online banking authentication between the client system and the alternative interaction system. In some other embodiments, the processing device determines the alternative interaction system is incapable of providing authentication, identifies a second alternative interaction system capable of providing authentication and initiates online authentication between the client system and the second alternative interaction system.

In some embodiments, step 470 also includes initiating exchange of online banking information between the client system and the alternative interaction system in response to the second request. The exchanged online banking information, in some such embodiments, includes non-current information regarding the one or more accounts owned by the client. In some embodiments, the non-current information is information regarding the one or more accounts stored from a previous time period, such as the previous day. In one embodiment, for example, the client uses the client system to authenticate an online banking session with the primary interaction system, which determines it is unable to retrieve current bank account information. The primary interaction system identifies an alternative interaction system having online banking information, such as previously stored account information, and is capable of retrieving the information and providing it to the client. In some such embodiments, the primary interaction system initiates an exchange between the client system and the alternative interaction system and then steps out of the picture, that is, the exchange is completed directly between the client system and the alternative interaction system. Whereas, in some other embodiments, after initiating the exchange between the client system and the alternative interaction system, the primary interaction system facilitates the exchange. In some such embodiments, the information is forwarded through the primary interaction system.

In some embodiments, wherein the processing device determines the primary interaction system is incapable of either providing online banking authentication in response to the first request or providing online banking information in response to the second request. In some such embodiments, the processing device identifies an alternative interaction system for providing both online banking authentication in response to the first request as well as online banking information in response to the second request. In some embodiments, the processing device identifies a first alternative interaction system for providing a response to one of the two requests, and identifies a second alternative interaction system for providing a response to the other of the two requests. In some embodiments, the processing device then initiates authentication and/or exchange with the identified one or two alternative interaction systems. As discussed above, in various embodiments, the processing device then facilitates either one or both of the interactions, that is, the authentication interaction and/or the information exchange interaction. Thus, depending on which processing device, that is, 122, 152, and/or 162, is performing the method steps, the primary interaction system, in some embodiments, both initiates and facilitates authentication and exchange. In various embodiments, the processing device 122 of the primary interaction system 120 merely initiates either one or both of the authentication interactions and/or the information exchange interactions, and other processing devices, such as processing device 152 of the alternative interaction system 150 facilitates completion of the authentication interaction and/or the exchange interaction.

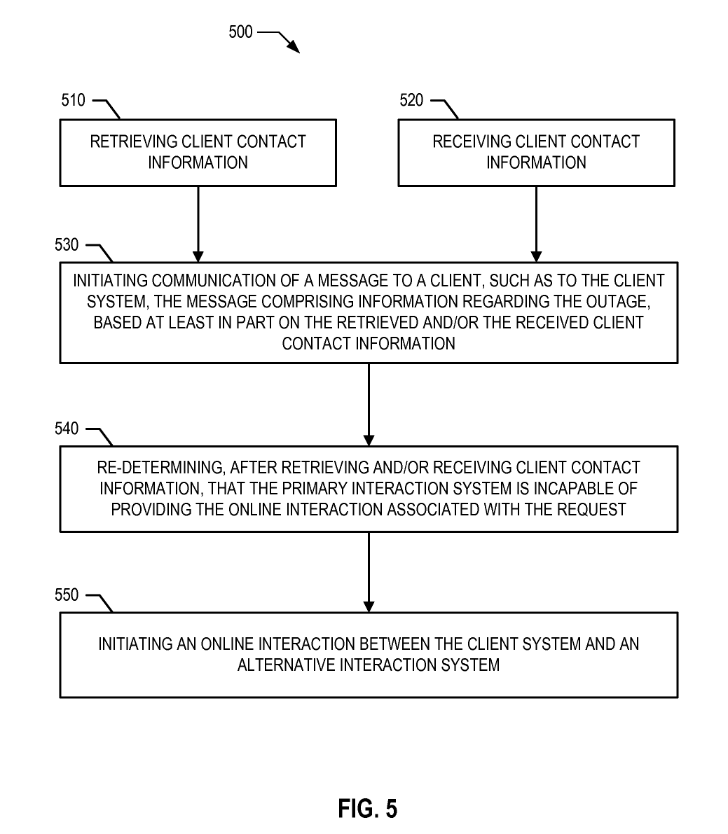

Referring now to FIG. 5, a flowchart illustrates a method 500 for communicating a message to a client regarding an online functionality outage according to embodiments of the invention. As represented by block 510, the first step is retrieving client contact information. In some embodiments, the client contact information is stored proximate the processing device performing the method 500. For example, in one embodiment, the processing device 122 of the primary interaction system 120 is performing method 500 and the client contact information is stored in the file system 124. The processing device 122 is configured for retrieving the client contact information from the file system 124. The client contact information, in various embodiments, was stored in the file system 134 of other file system for retrieval by one or more processing devices having access to the file system previous to execution of the method. For example, in some instances, the client, during or after setting up an online banking account inputs various pieces of information that are stored in one or more file systems maintained by the financial institution in one or more systems and/or servers. In some embodiments, the client contact information includes one or more email addresses, one or more mailing addresses, one or more physical addresses, one or more telephone numbers, and/or one or more other pieces of information tending to indicate a method by which to reach the client.

In various other embodiments, as represented by block 520, the processing device receives client contact information. In these embodiments, for example, a client or other person navigates to a webpage or other online content, such an online banking session without having contact information previously stored in one of the systems or servers maintained by the organization or financial institution. In some such embodiments, the client is prompted to enter contact information using the client system. The client system communicates the contact information to the processing device executing the method 500, such as, for example, processing device 122 through the network 102 and the communication device 126.

In some embodiments, as represented by block 530, the prompt for inputting contact information is accompanied by a message indicating the status of the online interaction functionality. For example, in one embodiment, the processing device 122, upon receiving the request for interaction, prompts the client system for client input regarding contact information as well as informing the client of the outage in the system. In various embodiments, the processing device 122 informs the client of the severity of the outage including the pieces of the system that are out. For example, in some instances, the processing device informs the client that the online banking functionality is out but that regular navigation of the financial institution website is working properly. In some embodiments, the processing device also requests input form the client regarding whether to navigate to alternative interaction, such as would be facilitated by an alternative interaction system.

Next, as represented by block 540, the processing device re-determines, after retrieving and/or receiving client contact information, that the primary interaction system is incapable of providing the online interaction associated with the request. Finally, as represented by block 550, the processing device initiates an online interaction between the client system and an alternative interaction system.

As discussed above, in various embodiments, more than one alternative interaction system is identified and used during the initiation and/or facilitation steps of the various methods disclosed herein.

In various embodiments of the present invention, one or more of the processing devices 122, 152, and/or 162 of the systems 120, 150, and/or the server 160 perform one or more of the steps of methods 200, 300, 400, and/or 500. In various embodiments, the instructions for performing one or more of the steps of one or more of the methods are stored in the file systems 126, 156, and/or 166 with which the respective processing device(s) have access for retrieving the computer readable instructions.

In various embodiments wherein a plurality of systems and/or servers interact, one or more of the systems and/or servers are the same system and/or server and/or one or more of the components, such as the processing device(s), file system(s), and/or communication device(s) are the same. In one embodiment, for example, all of the method steps of any one or the various methods or some or all of the methods are performed by one processing device housed by one server maintained by a bank. All of the instructions for performing the various method steps are housed in one file system of the one server in some such embodiments. In other embodiments, for example, one server has one processing device and one file system for performing the various steps of the methods, and that one server communicates with various other servers or systems internally to an organization and/or over a wider network such as the Internet in order to facilitate, for example, determination of an alternative interaction system for providing requested online interaction.

Embodiments of the invention provide a system that maintains online functionality during an outage. The system includes a processing device configured for receiving a request for online interaction via a network from a client system and identifying a primary interaction system configured to respond to the request. The processing device is also configured for determining the primary interaction system is incapable of providing the online interaction associated with the request, identifying an alternative interaction system configured to respond to the request, and initiating an online interaction between the client system and the alternative interactive system. In some embodiments, the primary interaction system is incapable of providing website content, and the processing device initiates an exchange of alternative website content. In some embodiments, the primary interaction system is incapable of providing online banking information, and the alternative interaction system provides alternative online banking information such as non-current information regarding an account.

Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As used herein, unless specifically limited by the context, the term “transaction” may refer to a purchase of goods and/or services (collectively referred to herein as “products”), a withdrawal of funds, an electronic transfer of funds, a payment transaction, a credit transaction, a PIN change transaction or other interaction between a cardholder and the bank maintained a bank account owned by the cardholder. As used herein, a “bank card” refers to a credit card, debit card, ATM card, check card, or the like, or other payment device such as, but not limited to, those discussed above that are not cards. An “account” or “bank account” refers to a credit account, debit account, deposit account, demand deposit account (DDA), checking account, budgeting account or the like. Although the phrases “bank card” and “bank account” include the term “bank,” the card or payment device need not be issued by a bank, and the account need not be maintained by a bank and may instead be issued by and/or maintained by other financial institutions.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for maintaining online functionality during an outage, the method comprising:
receiving, at a processing device, a request for online interaction via a network from a client system;
determining, by the processing device, the primary interaction system is incapable of providing the online interaction associated with the request; and
initiating, by the processing device, an online interaction between the client system and an alternative interaction system.

2. The method of claim 1, further comprising:
identifying, by the processing device, a primary interaction system configured to respond to the request.

3. The method of claim 1, further comprising:
identifying, by the processing device, the alternative interaction system configured to respond to the request.

4. The method of claim 1, wherein the request for online interaction comprises a request for website content.

5. The method of claim 4, wherein determining the primary interaction system is incapable of providing the online interaction associated with the request comprises determining the primary interaction system is incapable of providing the requested website content.

6. The method of claim 5, wherein initiating an online interaction between the client system and the alternative interaction system comprises initiating an exchange of alternative website content between the client system and the alternative interaction system.

7. The method of claim 1, wherein the request for online interaction comprises a request for online banking

8. The method of claim 7, wherein initiating an online interaction between the client system and an alternative interaction system comprises initiating an online banking session between the client system and the alternative interaction system.

9. The method of claim 7, wherein the request for online banking comprises a first request for online banking authentication and a second request for online banking information, wherein determining the primary interaction system is incapable of providing the online interaction associated with the request comprises determining the primary interaction system is capable of providing authentication in response to the first request and is incapable of providing online banking information.

10. The method of claim 9, wherein the alternative interaction system is configured for providing alternative online banking information in response to the second request.

11. The method of claim 10, wherein the requested online banking information comprises current information regarding one or more accounts and the alternative online banking information comprises non-current information regarding one or more accounts.

12. The method of claim 11, wherein the non-current information regarding one or more accounts comprises previous day information regarding the one or more accounts.

13. The method of claim 1, further comprising:
initiating, by the processing device, communication of a message to a client, the message comprising information regarding the outage.

14. The method of claim 13, wherein initiating communication of a message to a client is based at least in part on retrieved client contact information.

15. The method of claim 13, further comprising:
receiving, by the processing device, client contact information; and
wherein initiating communication of a message to a client is based at least in part on the received client contact information.

16. The method of claim 13, wherein initiating communication of a message to a client comprises initiating communication of a message to the client system via the network.

17. The method of claim 13, further comprising:
receiving, by the processing device, client contact information; and
re-determining, after receiving the client contact information, by the processing device, that the primary interaction system is incapable of providing the online interaction associated with the request.

18. The method of claim 13, wherein initiating an online interaction between the client system and an alternative interaction system is performed at least in part concurrently with initiating communication of a message to a client.

19. A system for maintaining online functionality during an outage, the system comprising:
a processing device configured for:
receiving a request for online interaction via a network from a client system;
determining a primary interaction system is incapable of providing the online interaction associated with the request; and
initiating an online interaction between the client system and an alternative interaction system.

20. The system of claim 19, wherein the processing device is further configured for:
identifying a primary interaction system configured to respond to the request.

21. The system of claim 19, wherein the processing device is further configured for:
identifying the alternative interaction system configured to respond to the request.

22. The system of claim 19, wherein the request for online interaction comprises a request for website content.

23. The system of claim 22, wherein determining the primary interaction system is incapable of providing the online interaction associated with the request comprises determining the primary interaction system is incapable of providing the requested website content.

24. The system of claim 23, wherein initiating an online interaction between the client system and the alternative interaction system comprises initiating an exchange of alternative website content between the client system and the alternative interaction system.

25. The system of claim 19, wherein the request for online interaction comprises a request for online banking

26. The system of claim 25, wherein initiating an online interaction between the client system and an alternative interaction system comprises initiating an online banking session between the client system and the alternative interaction system.

27. The system of claim 25, wherein the request for online banking comprises a first request for online banking authentication and a second request for online banking information, wherein determining the primary interaction system is incapable of providing the online interaction associated with the request comprises determining the primary interaction system is capable of providing authentication in response to the first request and is incapable of providing online banking information.

28. The system of claim 27, wherein the alternative interaction system is configured for providing alternative online banking information in response to the second request.

29. The system of claim 28, wherein the requested online banking information comprises current information regarding one or more accounts and the alternative online banking information comprises non-current information regarding one or more accounts.

30. The system of claim 29, wherein the non-current information regarding one or more accounts comprises previous day information regarding the one or more accounts.

31. The system of claim 19, the processing device further configured for:
initiating communication of a message to a client, the message comprising information regarding the outage.

32. The system of claim 31, wherein initiating communication of a message to a client is based at least in part on retrieved client contact information.

33. The system of claim 31, where the processing device is further configured for:
receiving client contact information; and
wherein initiating communication of a message to a client is based at least in part on the received client contact information.

34. The system of claim 31, wherein initiating communication of a message to a client comprises initiating communication of a message to the client system via the network.

35. The system of claim 31, wherein the processing device is further configured for:
receiving client contact information; and
re-determining, after receiving the client contact information, that the primary interaction system is incapable of providing the online interaction associated with the request.

36. The system of claim 31, wherein initiating an online interaction between the client system and an alternative interaction system is performed at least in part concurrently with initiating communication of a message to a client.

37. A computer program product configured for maintaining online functionality during an outage, the computer program product comprising a non-transitory computer readable medium comprising computer-executable instructions stored therein, the computer-executable instructions comprising:
instructions for receiving a request for online interaction via a network from a client system;
instructions for determining the primary interaction system is incapable of providing the online interaction associated with the request; and
instructions for initiating an online interaction between the client system and an alternative interaction system.

38. The computer program product of claim 37, the instructions further comprising:
instructions for identifying a primary interaction system configured to respond to the request.

39. The computer program product of claim 37, the instructions further comprising:
instructions for identifying the alternative interaction system configured to respond to the request.

40. The computer program product of claim 37, wherein the request for online interaction comprises a request for website content.

41. The computer program product of claim 40, wherein the instructions for determining the primary interaction system is incapable of providing the online interaction associated with the request comprise instructions for determining the primary interaction system is incapable of providing the requested website content.

42. The computer program product of claim 41, wherein the instructions for initiating an online interaction between the client system and the alternative interaction system comprise instructions for initiating an exchange of alternative website content between the client system and the alternative interaction system.

43. The computer program product of claim 37, wherein the request for online interaction comprises a request for online banking

44. The computer program product of claim 43, wherein the instructions for initiating an online interaction between the client system and an alternative interaction system comprise instructions for initiating an online banking session between the client system and the alternative interaction system.

45. The computer program product of claim 43, wherein the request for online banking comprises a first request for online banking authentication and a second request for online banking information, and wherein:
the instructions for determining the primary interaction system is incapable of providing the online interaction associated with the request comprise instructions for determining the primary interaction system is capable of providing authentication in response to the first request and is incapable of providing online banking information.

46. The computer program product of claim 45, wherein the alternative interaction system is configured for providing alternative online banking information in response to the second request.

47. The computer program product of claim 46, wherein the requested online banking information comprises current information regarding one or more accounts and the alternative online banking information comprises non-current information regarding one or more accounts.

48. The computer program product of claim 47, wherein the non-current information regarding one or more accounts comprises previous day information regarding the one or more accounts.

49. The computer program product of claim 37, wherein the instructions further comprise:
initiating communication of a message to a client, the message comprising information regarding the outage.

50. The computer program product of claim 49, wherein the instructions for initiating communication of a message to a client comprise instructions for initiating communication of a message to a client based at least in part on retrieved client contact information.

51. The computer program product of claim 49, wherein the instructions further comprise:
instructions for receiving client contact information; and
wherein the instructions for initiating communication of a message to a client comprise instructions for initiating communication of a message to a client based at least in part on the received client contact information.

52. The computer program product of claim 49, wherein the instructions for initiating communication of a message to a client comprise instructions for initiating communication of a message to the client system via the network.

53. The computer program product of claim 49, wherein the instructions further comprise:
instructions for receiving client contact information; and
instructions for re-determining, after receiving the client contact information that the primary interaction system is incapable of providing the online interaction associated with the request.

54. The computer program product of claim 49, wherein the instructions further comprise instructions for initiating an online interaction between the client system and an alternative interaction system and, at least in part concurrently, initiating communication of a message to a client.

55. A method for maintaining online functionality during an outage, the method comprising:
receiving, at a processing device, a request for online interaction comprising a request for website content via a network from a client system;
identifying, by the processing device, a primary interaction system configured to respond to the request;
determining, by the processing device, the primary interaction system is incapable of providing the online interaction, including the website content, associated with the request;
identifying, by the processing device, the alternative interaction system configured to respond to the request; and
initiating, by the processing device, an online interaction between the client system and an alternative interaction system comprising initiating, by the processing device, an exchange of alternative website content between the client system and the alternative interaction system.

56. A method for maintaining online functionality during an outage, the method comprising:
receiving, at a processing device, a request for online interaction via a network from a client system, the request comprising a first request for online banking authentication and a second request for online banking information determining, by the processing device, the primary interaction system is incapable of providing online banking information in response to the request; and
initiating, by the processing device, an online interaction between the client system and an alternative interaction system configured for providing alternative online banking information in response to the second request, the online banking information comprising current information regarding one or more accounts and the alternative online banking information comprising non-current information regarding one or more accounts.

57. The method of claim 56, wherein the non-current information regarding one or more accounts comprises previous day information regarding the one or more accounts.
